(19) United States
(12) Patent Application Publication
(10) Pub. No.: US 2024/0110578 A1
(43) Pub. Date: Apr. 4, 2024

(54) END-SUCTION PUMP WITH DUAL INLET IMPELLER

(71) Applicant: ITT MANUFACTURING ENTERPRISES LLC, Wilmington, DE (US)

(72) Inventor: Abraham RUPER, Seneca Falls, NY (US)

(73) Assignee: ITT MANUFACTURING ENTERPRISES LLC, Wilmington, DE (US)

(21) Appl. No.: 18/256,154

(22) PCT Filed: Dec. 11, 2020
(86) PCT No.: PCT/US20/64457

§ 371 Date: Jun. 6, 2023

(51) Int. Cl. F04D 29/42; F04D 1/00; F04D 13/02; F04D 29/24

(52) U.S. Cl. CPC F04D 29/4273; F04D 1/006; F04D 13/027; F04D 29/24

(57) ABSTRACT

Technologies are generally described for end-suction pumps that are adapted for a dual inlet impeller. Example end suction pumps includes a body casing with a pump housing, a single inlet, a single outlet, and a magnetically coupled drive to effectuate drive to the impeller in the body casing. Fluid flows to one side of the impeller (e.g., a right-eye side) via a primary flow path from an impeller inlet of the body casing, and also to another side of the impeller (e.g., a left-side eye) via a secondary flow path through a stationary shaft with a semi-hollow hydraulic passageway therein.

### BACKGROUND

Unless otherwise indicated herein, the materials described in this section are not prior art to the claims in this application and are not admitted as prior art by inclusion in this section.

End suction pumps are centrifugal pumps that move fluid by transferring rotational energy from driven rotors, called impellers. Fluid enters the centrifugal pump at an inlet, where an impeller is located. A motor is utilized to rotate a shaft that is connected to the impeller, thereby controlling the rotational of the impeller. The rotational motion of the impeller generates a centrifugal force that increases the velocity of the fluid so that the fluid flows through the pump casing to an outlet.

The design of the centrifugal pump depends on the type of fluid and the desired flow rate. High capacity pumping applications typically involve low viscosity fluids such as water, solvents, chemicals and light oils. Some typical applications of pumps include water supplies, circulation pumps, irrigation pumps, and chemical transfer pumps.

### SUMMARY

The present disclosure generally describes an end suction pump that utilizes a semi-hollow stationary shaft to implement dual fluid paths to the impeller from a single fluid inlet.

In some examples, an end suction pump apparatus is described herein that comprises a pump casing, an impeller, and a semi-hollow stationary shaft. The pump casing may have an inlet port and an outlet port. An impeller may be located within the pump casing, where the impeller has a left eye side and a right eye side. The semi-hollow stationary shaft may be located within the pump casing. The impeller may be located about a circumference of the shaft. The right-side eye of the impeller may be configured to receive fluid via a primary flow path from the inlet port of the pump casing. The left-side eye of the impeller may be configured to receive fluid via a secondary flow path from the inlet port of the pump casing through a body of the semi-hollow stationary shaft.

In various examples, an end suction pump apparatus is described that comprises a pump body casing, a magnet carrier, an impeller, and a semi-hollow stationary shaft. The pump body casing may have an inlet port, an outlet port, and a driver mounting face that is configured to couple to an external driver. The magnetic carrier may be located within the pump body casing and positioned to magnetically couple to magnetic material of the external driver. The impeller may be located within the pump body casing and coupled to the magnet carrier such that the impeller rotates responsive to motion of the magnetic material of the external driver, where the impeller has a left-eye side and a right-eye side. The semi-hollow stationary shaft may be located within the pump casing. The impeller may be located about a circumference of the shaft, where a right-side eye of the impeller may be configured to receive fluid via a primary flow path from the inlet port of the pump casing, and where a left-side eye of the impeller may be configured to receive fluid via a secondary flow path from the inlet port of the pump casing through a body of the semi-hollow stationary shaft.

Some example end suction pumps described herein may further comprise a discharge path from the impeller to the outlet port of the pump casing. Also, the semi-hollow stationary shaft may further comprise an inlet portion, on outlet portion that is coupled to the inlet port of the pump casing, and an outlet portion that is positioned about the left-side eye of the impeller.

In some further examples, the semi-hollow stationary shaft may further comprise one or more vanes that extend from the inlet portion to the outlet portion thereof. For example, the semi-hollow stationary shaft may further comprise one or more vanes, or three or more vanes, that extend from the inlet portion to corresponding outlet portions thereof. Some examples of the semi-hollow stationary shaft may comprise one or more of a semi-hollow metallic material, a semi-hollow non-metallic material, a reinforcement material, or a combination thereof.

The impeller of some example end suction pumps described herein may further comprise one or more fan blades located about the circumference of the semi-hollow stationary shaft. The impeller may further comprise an impeller cover that covers the fan blades within the body casing. The impeller may be comprised of one or more of a metallic material, a non-metallic material, a reinforcement material, or a combination thereof.

In some examples described herein, the semi-hollow stationary shaft and the pump casing of the end suction pump may be arranged such that the primary flow path and the secondary flow path each comprise 50% of the overall flow from the inlet port of the pump casing. Some example end suction pumps may include a magnet carrier that is positioned within the pump casing and coupled to the impeller such that motion of the magnet carrier results in rotational motion of the impeller.

In still other examples, an end suction pump apparatus is described that comprises a pump body casing, a magnetic carrier, a semi-hollow stationary shaft, and an impeller. The pump body casing may include an inlet port, an outlet port, a primary impeller inlet, a secondary impeller inlet, and a driver mounting face that is configured to couple to an external driver. The magnet carrier may be located within the pump body casing and positioned to magnetically couple to magnetic material of the external driver. The semi-hollow stationary shaft may be located within the pump casing, where an inlet of the semi-hollow stationary shaft is coupled to the inlet port of the pump casing, and an outlet of the semi-hollow stationary shaft is coupled to the secondary impeller inlet of the pump body casing, and where the semi-hollow stationary shaft has a hydraulic passageway therein. The impeller may be circumferentially located about the semi-hollow stationary shaft within the pump body casing, where the impeller is coupled to the magnet carrier such that the impeller rotates responsive to motion of the magnetic material of the external driver, and where the impeller has a right-eye side that faces the primary impeller inlet, and a left-eye side that faces the secondary impeller inlet.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example end suction pump with a dual inlet impeller;

FIGS. 2A and 2B illustrate a detailed cut assembly view of an end suction pump with a dual inlet impeller;

FIG. 3 illustrate a conceptual cut assembly view of an end suction pump with a dual inlet impeller;

FIG. 4 illustrates a semi-hollow stationary shaft for an end suction pump with a dual inlet impeller;

FIG. 5 illustrates an impeller and shaft for an end suction pump with a dual inlet impeller; and

FIG. 6 illustrates operational flow of an end suction pump with a dual inlet impeller;

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems and/or magnetically driven pump devices that employ a dual inlet impeller design with substantially the same footprint as an end-suction pump.

Briefly stated, technologies are generally described for pumps that include a dual inlet impeller design. The rotating element of the pump can be magnetically coupled to a motor to drive the impeller. A single flange design may be employed where a primary impeller inlet delivers fluid to one side of the impeller, and a second impeller inlet delivers fluid to another side of the impeller via a stationary shaft with semi-hollow hydraulic passageways therein.

The present disclosure recognizes that end suction pumps are generally available at lower cost than double suction pumps, but at the cost of reduced reliability and limited use. End suction pumps are used in a wider array of applications, and thus end suction pumps have a higher installation base than double suction pumps. On the other hand, double suction pumps have higher reliability and are adept in low suction pressure applications.

Customers often select ANSI/ISO type process pump applications where damaging and/or corrosive chemicals are present. Magnetically driven pumps are typically designed as end-suction pumps compliant with ANSI/ISO dimensional standards. A magnetically driven pump eliminates the requirement for a mechanical shaft seal and is thus superior in performance in harsh chemical environments. Therefore magnetically driven end-suction pumps are often swapped in for those common process pumps in servicing highly corrosive or toxic chemicals.

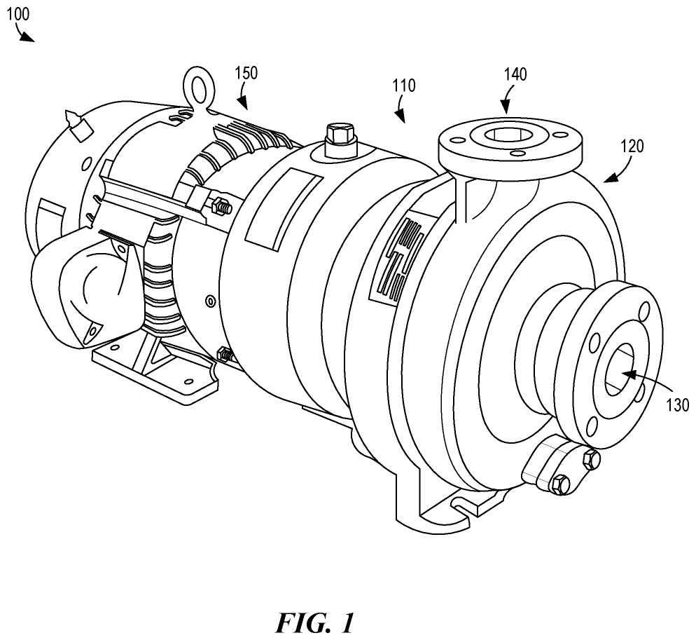

FIG. 1 illustrates an example end suction pump 100 with a dual inlet impeller, arranged in accordance with at least some embodiments described herein. The illustrated end suction pump 100 includes a body casing 110 with a pump housing 120, a single inlet flange 130, and a single outlet flange 140. The end suction pump 100 further includes a magnetically coupled drive 150 that is mated to the body casing 110 to effectuate drive to the impeller in the pump housing 120. The inlet 130 of the pump housing delivers fluid to one side of the impeller (e.g., a right-eye side) via a primary flow path from an impeller inlet of the body casing, and also to another side of the impeller (e.g., a left-side eye) via a secondary flow path through the stationary shaft with a semi-hollow hydraulic passageway therein.

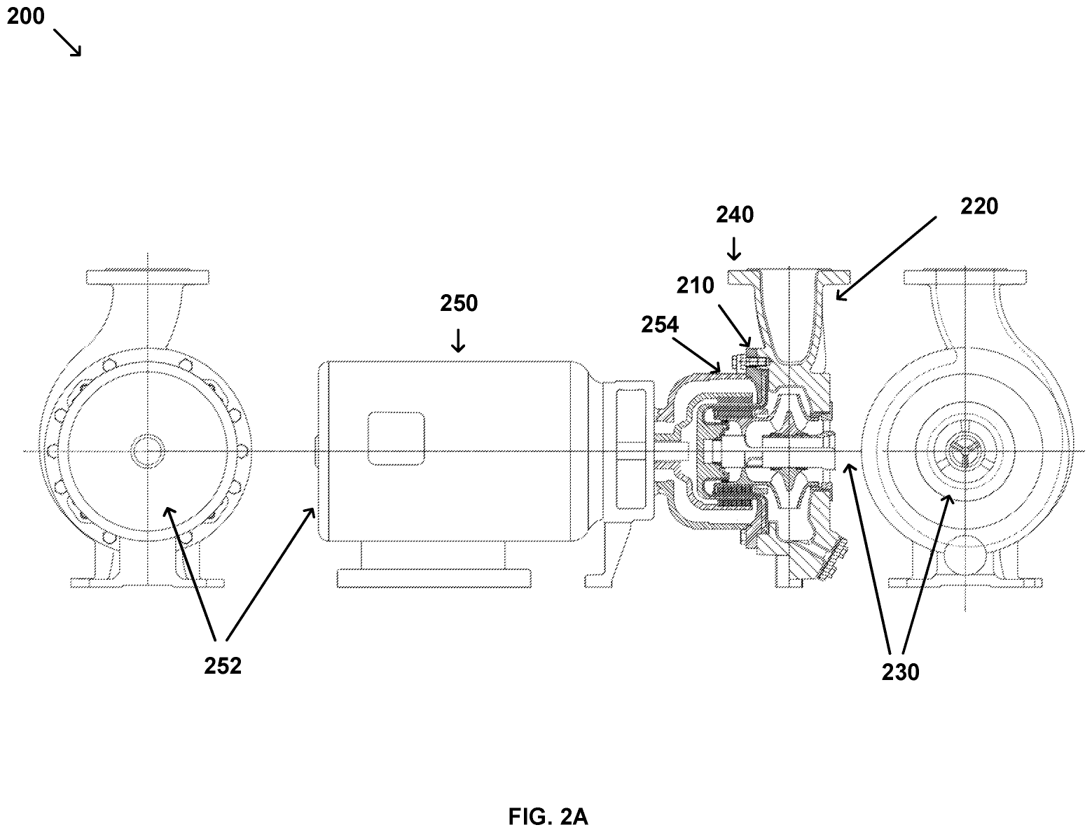

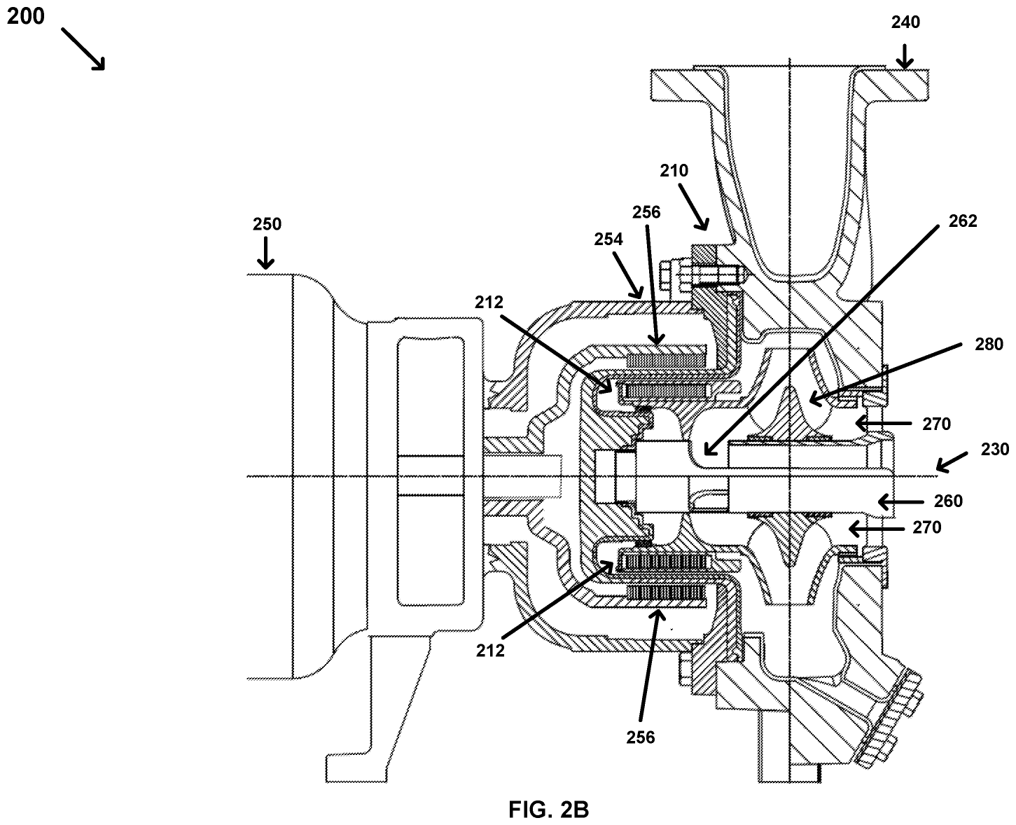

FIGS. 2A and 2B illustrate a detailed cut views of an example end suction pump 200 with a dual inlet impeller, arranged in accordance with at least some embodiments described herein. As illustrated in FIG. 2A, the example end suction pump 200 includes a body casing 210 with a pump housing 220, a single inlet flange 230, and a single outlet flange 240. The end suction pump 100 further includes a magnetically coupled drive 250 that includes a first end 252, illustrated on the left-hand side cross-sectional view, and a second end 254. The second end 254 is coupled to the body casing 210 to effectuate drive to the impeller in the pump housing 220. The inlet 230, which is further illustrated on the right hand side cross-sectional view, is configured to deliver fluid to one side of the impeller via an impeller inlet, and a second impeller inlet delivers fluid to another side of the impeller via a stationary shaft with a semi-hollow hydraulic passageway therein.

FIG. 2B illustrates a close-up cut view of the example end suction pump 200 of FIG. 2A, with additional details identified. As shown, end suction pump 200 includes a drive 250 with an end 254 that is coupled (e.g., via a fastener such as a bolt, rivet, screw, etc.) to the body casing 210. At end 254, drive magnets 256 are positioned to magnetically couple with the pump magnets 212 that are located within the body casing 210. A stationary shaft extends from an inlet side (e.g., about inlet 230) of the body casing 210 towards the drive end of the body casing 210. An impeller 280 is circumferentially located about the stationary shaft 260, where the impeller 280 is configured to rotate about the stationary shaft responsive to the motion of the drive 250 through magnetic coupling. Inlet 230 is located about an aperture (e.g., an inlet portion) of the stationary shaft 260, where the stationary shaft 260 has a semi-hollow hydraulic passageway therein to couple fluid from the inlet 230 to an outlet 262 on one side (e.g., from the left-eye side of the impeller) of the impeller 280. Another inlet 270 is located about the exterior of the stationary shaft 260 and configured to couple fluid from inlet 230 to another side of the impeller 280 (e.g., from the right-eye side of the impeller).

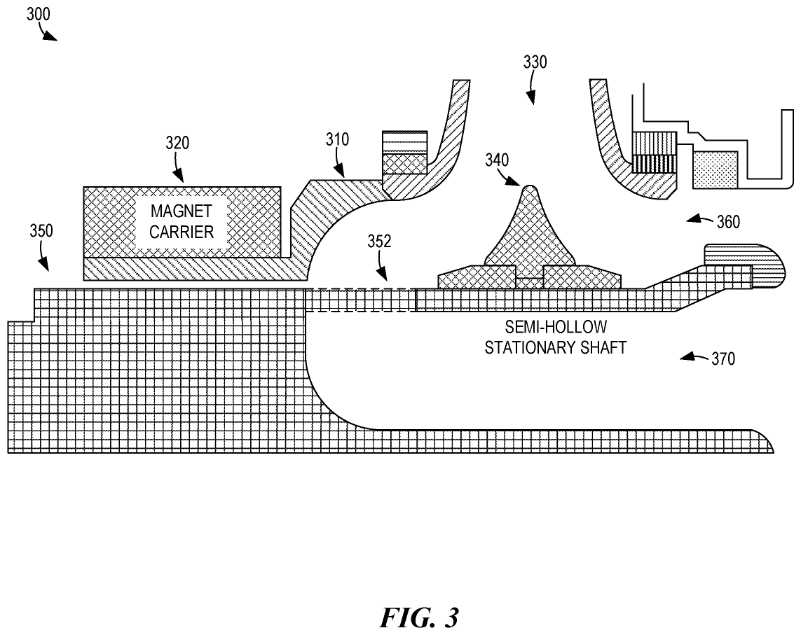

FIG. 3 illustrate a conceptual cut assembly view of an end suction pump 300 with a dual inlet impeller in accordance with aspects of embodiments described herein. The operation of pump 300 is substantially similar to pump 200 illustrated in FIG. 2, with a simplified view for the purpose of clarity. End suction pump 300 includes a pump casing 310 with a magnet carrier 320, a single inlet flange (not shown) and a single output flange 330. The single inlet flange (not shown) provides fluid to a primary impeller inlet 360, which is located at one side (e.g., a right-eye side) of the impeller 340 in the pump casing 310. The single inlet flange (not shown) also provides fluid to a semi-hollow stationary shaft 350, which provides a hydraulic inlet path 370 through an aperture 352 in the shaft 350 to another side (e.g., a left-eye side) of the impeller 340 in the pump housing 310.

The magnetic carrier 320 is configured to rotate the impeller 340 to generate suction during the operation of the pump. The magnetic coupling of the drive is advantageous to provide a seal free pump, which has the benefit of being able to pump corrosive materials without compromising the seals. Magnetically driven pumps do not require a rotating shaft, and thus the shaft is can be implemented as a solid shaft that is stationary. Recognizing the shortcomings of the end suction pump design, the present disclosure contemplates a new design that modifies the end suction pump with a semi-hollow shaft that can deliver hydraulic fluid through passageways in the shaft to the impeller. This will become more apparent in the FIG. 3 discussion.

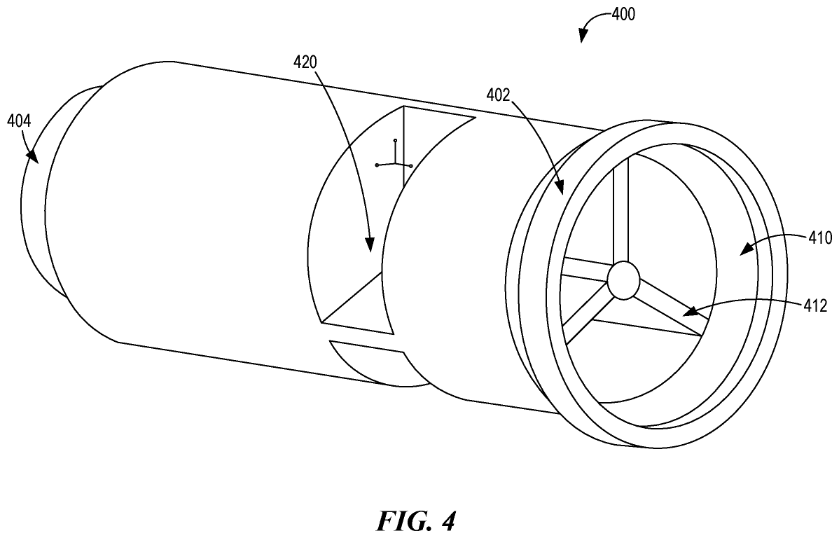

FIG. 4 illustrates a semi-hollow stationary shaft 400 for an end suction pump with a dual inlet impeller, arranged in accordance with at least some embodiments described herein. The shaft is illustrated with multiple hydraulic fluid passageways. In this example, starting from the right, the shaft 400 is attached to the pump casing by a stationary bearing (not shown). Fluid enters the shaft on the inlet end 402, shown on the right side where an inlet aperture 410 is located. The interior of the shaft 400 may include multiple vanes 412 or rib-like structures (e.g. 3-vanes, 4-vanes, . . . N-vanes) that provide structural support (e.g., rigidity) to the shaft. The vanes or ribs 412 extend along an interior of the shaft from the inlet end 402 (e.g., by inlet aperture 410) to an outlet aperture 420 that is located towards the opposite end 404 of the shaft 400. There may be multiple apertures 420, where in this example are illustrated as approximately mid-way along the shaft 400 between the inlet end 402 and the opposite end 404. Hydraulic fluid from the inlet flange (not shown) can enter the interior of the shaft 400 and travel along the vanes and exit at one of the apertures 420. The vanes 412 thus provide the dual role of structural support for the shaft as well as operating as a hydraulic fluid passage, which can thus direct hydraulic fluid to the impeller (e.g., see FIGS. 2 and 3).

The shaft may be made of either metallic or non-metallic materials. Some example non-metallic materials may include, resin or plastic based materials, including but not limited to polytetrafluoroethylene (PTFE), polyoxymethylene (POM), Polyetheretherketone (PEEK), Polyamides, or combinations thereof. Some example metal shafts may be made of steel, stainless steel, cast iron, cast aluminum, or other alloys as may be required for the specific application. Some example shaft materials may further include reinforcement elements such as glass fiber, carbon fiber, ceramic, or other reinforcement materials that are suitable to increase the rigidity, durability, and/or other properties such as corrosion resistance.

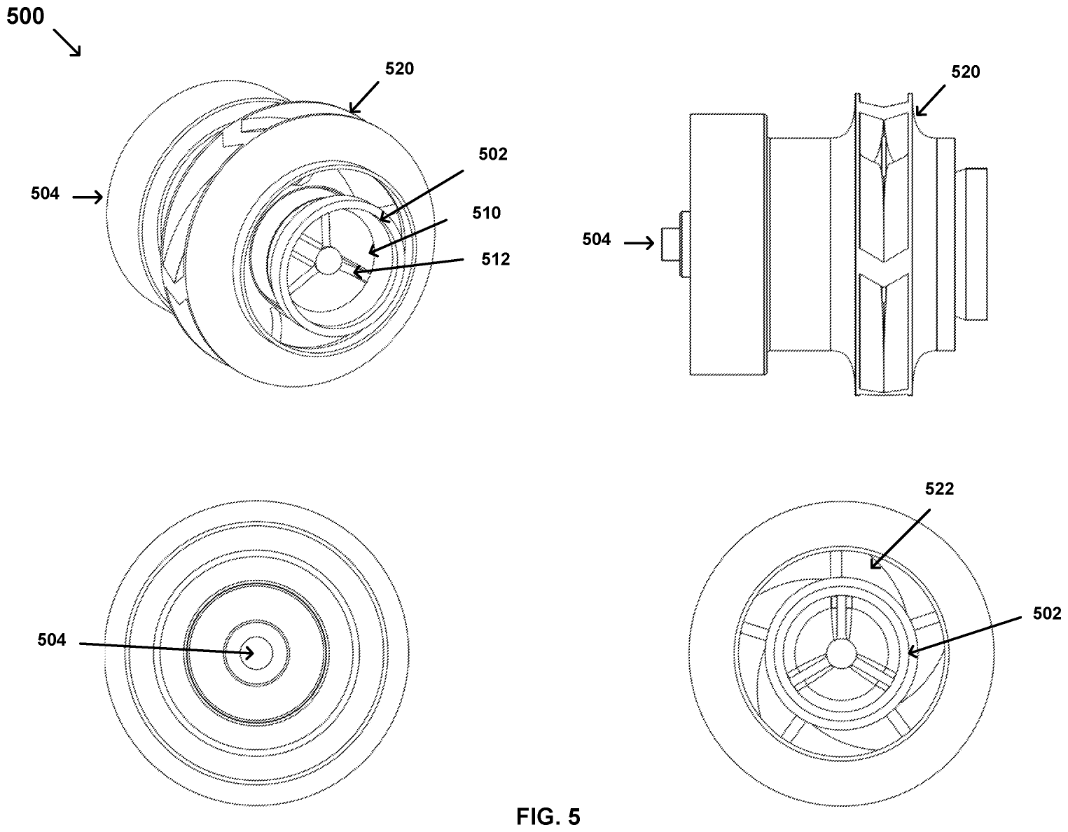

FIG. 5 illustrates an impeller and shaft for an end suction pump with a dual inlet impeller arranged in accordance with at least some embodiments described herein. The example impeller and shaft 500 are illustrated from a side view, end view, opposing end view, and a diagonal side view. As shown, the shaft portion includes an inlet end 502, and opposite end 504, an inlet 510, one or more vanes 512 that extend through the shaft to deliver fluid to the impeller through an outlet that is hidden from view in FIG. 5. The impeller includes one more fan blade portions 522 that are located under the impeller cover 520, each blade being arranged circumferentially around the shaft. The outlet may be arranged in deliver fluid to the impeller in a manner that is substantially similar as described previously with respect to FIGS. 3 and 4. Similar to the shaft, the impeller may be made of either metallic or non-metallic materials or a combination of either metallic, non-metallic or composite materials as may be required based on the specific environmental and operational requirements.

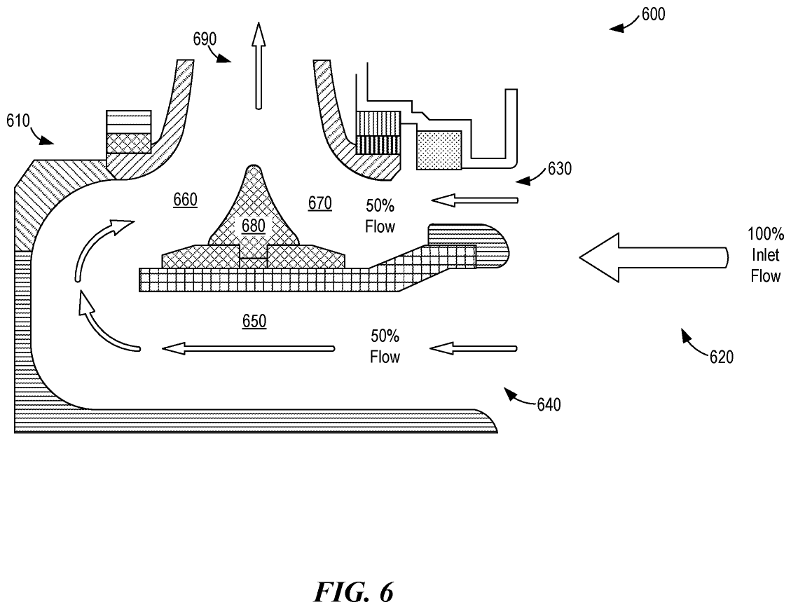

FIG. 6 illustrates operational flow of an end suction pump 600 with a dual inlet impeller arranged in accordance with aspects of the present disclosure. End suction pump 600 includes an inlet flow 620 from an inlet flange (e.g., see FIGS. 1, 2A, and 2B), where 100% of the hydraulic fluid is initially drawn into the pump housing 610. Once in the pump housing 610, the hydraulic fluid travels towards the shaft (e.g., see FIGS. 3 and 4), where the inlet flow 620 is split into two flow paths 630 and 640 that are approximately equivalent to one another. Thus, 50% of the inlet flow is directed to flow path 630 and 50% of the inlet flow is directed to flow path 640. Flow path 630 corresponds to a primary flow path where 50% of the inlet flow is delivered to a right side 670 of the impeller 680. Flow path 650 corresponds to the secondary flow path where 50% of the inlet flow 620 is delivered to the left side 660 of the impeller 680. Hydraulic fluid exits the pump housing 610 through an exit flange 690.

The split of the inlet flow to source hydraulic fluid to both sides of the impeller are facilitated by the vanes or ribs in the stationary shaft (e.g., see FIG. 4). Additional passages in the pump housing 610 may be utilized to guide hydraulic fluid from the stationary shaft to the impeller 680. Thus, the modification of the stationary shaft to guide fluid is a novel approach to provide a suction passage to allow a double suction impeller to operate in an end suction pump.

One benefit of the described pump design is that the axial forces acting on the impeller are substantially balanced since fluid is delivered to both sides of the impeller. The forces on the rotor are substantially symmetric about the impeller by this described operation.

An end suction pump arrangement with dual inlet impeller has a number of advantages over conventional end suction pumps. One benefit is that in low suction pressure applications dual inlet pumps operate more efficiently than single inlet pumps. Another benefit is that there is improved mechanical reliability from a hydraulically balanced design (e.g., the hydraulic fluid is provided equally at both sides of the impeller) with a fully supported shaft. These advantages are achieved while maintaining an end suction pump configuration that includes the dual inlet arrangement that is hidden within the pump housing. The end suction pump may be desired in that it has a smaller footprint and thus may be less costly to deploy.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims. The present disclosure is to be limited only by the terms of the appended claims, along with the full scope of equivalents to which such claims are entitled. The terminology used herein is for the purpose of describing particular embodiments only and is not intended to be limiting.

The herein described subject matter sometimes illustrates different components contained within, or connected with, different other components. Such depicted architectures are merely examples, and in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

For any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

What is claimed is:

1. An end suction pump apparatus comprising:
a pump casing that has an inlet port and an outlet port;
an impeller located within the pump casing, wherein the impeller has a left eye side and a right eye side; and
a semi-hollow stationary shaft within the pump casing,
wherein:
the impeller is located about a circumference of the shaft;
a right-side eye of the impeller is configured to receive fluid via a primary flow path from the inlet port of the pump casing; and
a left-side eye of the impeller is configured to receive fluid via a secondary flow path from the inlet port of the pump casing through a body of the semi-hollow stationary shaft.

2. The end suction pump of claim 1, further comprising a discharge path from the impeller to the outlet port of the pump casing.

3. The end suction pump of claim 1, the semi-hollow stationary shaft further comprising an inlet portion, on outlet portion that is coupled to the inlet port of the pump casing, and an outlet portion that is positioned about the left-side eye of the impeller.

4. The end suction pump of claim 3, the semi-hollow stationary shaft further comprising one or more vanes that extend from the inlet portion to the outlet portion thereof.

5. The end suction pump of claim 3, the semi-hollow stationary shaft further comprising three or more vanes that extend from the inlet portion to corresponding outlet portions thereof.

6. The end suction pump of claim 3, the semi-hollow stationary shaft comprising one or more of a semi-hollow metallic material, a semi-hollow non-metallic material, a reinforcement material, or a combination thereof.

7. The end suction pump of claim 1, the impeller further comprising one or more fan blades located about the circumference of the semi-hollow stationary shaft.

8. The end suction pump of claim 7, the impeller further comprising an impeller cover that is covers the fan blades within the body casing.

9. The end suction pump of claim 1, the impeller comprising one or more of a metallic material, a non-metallic material, a reinforcement material, or a combination thereof.

10. The end suction pump of claim 1, wherein the semi-hollow stationary shaft and the pump casing are arranged such that the primary flow path and the secondary flow path each comprise 50% of the overall flow from the inlet port of the pump casing.

11. The end suction pump of claim 1, further comprising a magnet carrier that is positioned within the pump casing and coupled to the impeller such that motion of the magnet carrier results in rotational motion of the impeller.

12. An end suction pump apparatus comprising:
a pump body casing that has an inlet port, an outlet port, and a driver mounting face that is configured to couple to an external driver;
a magnet carrier that is located within the pump body casing and positioned to magnetically couple to magnetic material of the external driver;
an impeller that is located within the pump body casing and coupled to the magnet carrier such that the impeller rotates responsive to motion of the magnetic material of the external driver, wherein the impeller has a left-eye side and a right-eye side; and
a semi-hollow stationary shaft within the pump casing,
wherein:
the impeller is located about a circumference of the shaft;
a right-side eye of the impeller is configured to receive fluid via a primary flow path from the inlet port of the pump casing; and
a left-side eye of the impeller is configured to receive fluid via a secondary flow path from the inlet port of the pump casing through a body of the semi-hollow stationary shaft.

13. The end suction pump of claim 12, further comprising a discharge path from the impeller to the outlet port of the pump casing.

14. The end suction pump of claim 12, the semi-hollow stationary shaft further comprising an inlet portion, on outlet portion that is coupled to the inlet port of the pump casing, and an outlet portion that is positioned about the left-side eye of the impeller.

15. The end suction pump of claim 14, the semi-hollow stationary shaft further comprising one or more vanes that extend from the inlet portion to the outlet portion thereof.

16. The end suction pump of claim 12, the impeller further comprising one or more fan blades located about the circumference of the semi-hollow stationary shaft.

17. The end suction pump of claim 12, wherein the semi-hollow stationary shaft and the pump casing are arranged such that the primary flow path and the secondary flow path each comprise 50% of the overall flow from the inlet port of the pump casing.

18. An end suction pump apparatus, comprising:
a pump body casing that has an inlet port, an outlet port, a primary impeller inlet, a secondary impeller inlet, and a driver mounting face that is configured to couple to an external driver;
a magnet carrier that is located within the pump body casing and positioned to magnetically couple to magnetic material of the external driver;
a semi-hollow stationary shaft within the pump casing, wherein an inlet of the semi-hollow stationary shaft is coupled to the inlet port of the pump casing, and an outlet of the semi-hollow stationary shaft is coupled to the secondary impeller inlet of the pump body casing, and wherein the semi-hollow stationary shaft has a hydraulic passageway therein; and
an impeller that is circumferentially located about the semi-hollow stationary shaft within the pump body casing, wherein the impeller is coupled to the magnet carrier such that the impeller rotates responsive to motion of the magnetic material of the external driver, wherein the impeller has a right-eye side that faces the primary impeller inlet, and a left-eye side that faces the secondary impeller inlet.
